(19) United States
(12) Patent Application Publication
(10) Pub. No.: US 2004/0083050 A1
(43) Pub. Date: Apr. 29, 2004

(54) System and method for obtaining driving directions

(76) Inventor: Veena Biyani, Irving, TX (US)

Correspondence Address: Richard C. Litman, LITMAN LAW OFFICES, LTD., P. O. Box 15035, Arlington, VA, 22215, US

(21) Appl. No.: 10/279,930

(22) Filed: Oct. 25, 2002

(51) Int. Cl. G01C 21/34

(52) U.S. Cl. 701/200; 701/202

(57) ABSTRACT

A system and method for obtaining driving directions that includes a user communication device and an address/mapping communication device, wherein the address/mapping communication device provides driving directions to the user communication device based on ‘from’ and ‘to’ telephone number data.

### BACKGROUND OF THE INVENTION

1. Field of the Invention

The present invention relates to communication systems and, more particularly, to a system and method for obtaining driving directions.

2. Description of the Related Art

One of the inefficiencies of the regular 411 information service is the inability of the information service to provide callers with driving directions services. Location based telephone service, which is available, is the extending of a telephone call from the caller to a service provider serving the area from which the telephone call is being placed. Some examples of location based telephone services are the 911 emergency telephone service and toll-free telephone numbers for franchises that connect a caller to the nearest outlet of the associated franchise serving the subscriber. However, there is currently not a service available that provides customers with user friendly driving directions based on ‘to’ and ‘from’ telephone numbers. A need exists for a service that provides customers with user friendly driving directions based on ‘to’ and ‘from’ telephone numbers. The related art is represented by the following references of interest.

U.S. patent application Publication Ser. No. 2002/0,072,377 A1, published on Jun. 13, 2002 for Rodric C. Fan et al., describes a position method in a mobile telephone number of a wireline telephone and a reverse phone-book operation for determining the location of a mobile unit. The Fan et al. application does not suggest a system and method for obtaining driving directions according to the claimed invention.

U.S. patent application Publication Ser. No. 2002/0,115,431 A1, published on Aug. 22, 2002 for Patrick M. Cox et al., describes a telecommunication technique for providing information assistance services for cellular telephone subscribers. The Cox et al. application does not suggest a system and method for obtaining driving directions according to the claimed invention.

U.S. Pat. No. 5,097,528, issued on Mar. 17, 1992 to Suresh K. Gursahaney et al., describes a system for providing an automatic interface between a host based, menu driven application program and a telephone network. Gurasahaney et al. not suggest a system and method for obtaining driving directions according to the claimed invention.

U.S. Pat. No. 5,109,399, issued on Apr. 28, 1992 to Robert W. Thompson, describes a computer-based system for receiving emergency telephone calls which, upon receipt of a call, provides a voice connection to the operator as well as displaying a map showing the location of the calling party and other relevant textual information. Thompson does not suggest a system and method for obtaining driving directions according to the claimed invention.

U.S. Pat. No. 5,239,700, issued on Aug. 24, 1993 to Clemens Guenther et al., describes a visual display monitor of an information system of a motor vehicle that is connected not only with the usual engine and vehicle instrumentation, but also with a variety of electrical equipments installed in the motor vehicle which the driver may want to activate and control from time to time. Guenther et al. does not suggest a system and method for obtaining driving directions according to the claimed invention.

U.S. Pat. No. 5,353,023, issued on Oct. 4, 1994 to Tatsuya Mitsugi, describes a car navigation system for estimating a location of the car, detecting occurrence of an accident, storing information for use in analyzing the accident and performing communication with the outside. Mitsugi does not suggest a system and method for obtaining driving directions according to the claimed invention.

U.S. Pat. No. 5,515,426, issued on May 7, 1996 to Michael W. Yacenda et al., describes a telephone communication system having a locator system for locating telephone users and generating location information. Yacenda et al. does not suggest a system and method for obtaining driving directions according to the claimed invention.

U.S. Pat. No. 5,727,057, issued on Mar. 10, 1998 to Mark Emery et al., describes a method and system implementation for combining and accessing telephony numbering and geographical position so direct access to information, services and goods may be invoked through the use of various telephone networks. Emery et al. does not suggest a system and method for obtaining driving directions according to the claimed invention.

U.S. Pat. No. 5,729,457, issued on Mar. 17, 1998 to Leslie G. Seymour, describes a navigation system for determining an entry point from an unmatched location to a known route. Seymour does not suggest a system and method for obtaining driving directions according to the claimed invention.

U.S. Pat. No. 5,941,930, issued on Aug. 24, 1999 to Kyomi Morimoto et al., describes a navigation system for providing route guidance by searching for a route from a present position or starting point upon input of a location such as a destination or transit point. Morimoto et al. does not suggest a system and method for obtaining driving directions according to the claimed invention.

U.S. Pat. No. 6,040,829, issued on Mar. 21, 2000 to Clemens Croy et al., describes a hand-held device and system for monitoring and controlling electronic devices. Croy et al. does not suggest a system and method for obtaining driving directions according to the claimed invention.

U.S. Pat. No. 6,125,326, issued on Sep. 26, 2000 to Hiroshi Ohmura et al., describes a navigation system including a main navigation apparatus which is fixed to a vehicle and a sub-navigation apparatus which is detachable from the vehicle. Ohmura et al. does not suggest a system and method for obtaining driving directions according to the claimed invention.

U.S. Pat. No. 6,163,596, issued on Dec. 19, 2000 to Yair Gelfer et al., describes a system and method for generating and accessing a telephone directory. Gelfer et al. does not suggest a system and method for obtaining driving directions according to the claimed invention.

U.S. Pat. No. 6,240,391 B1, issued on May 29, 2001 to Thomas J. Ball et al., describes a system and method for assembling and presenting a structured electronic message that begins when a sender creates a voice-mail message that includes a plurality of messaging elements that include embedded instructions that define a structure of the message. Ball et al. does not suggest a system and method for obtaining driving directions according to the claimed invention.

U.S. Pat. No. 6,385,465 B1, issued on May 7, 2002 to Kazunori Yoshioka, describes a navigation device that includes a map database for storing map data, and a telephone number database for storing a plurality of locations and their telephone numbers, latitudes, and longitudes. Yoshioka does not suggest a system and method for obtaining driving directions according to the claimed invention.

U.S. Pat. No. 6,400,809 B1, issued on Jun. 4, 2002 to Robert W. Bossemeyer, Jr. et al., describes a method and system for providing audible caller information to telephone service subscribers. Bossemeyer, Jr. et al. does not suggest a system and method for obtaining driving directions according to the claimed invention.

U.S. Pat. No. 6,456,207 B1, issued on Sep. 24, 2002 to John Yen, describes an intelligent taxi total service system having an intelligent automatic management system, which provides automation functions such as inquiring, broadcasting, positioning, tracing, recording, searching, confirming, charging, receipt printing, navigating, real time traffic information, security, emergency help requesting, and emergency help communication. Yen does not suggest a system and method for obtaining driving directions according to the claimed invention.

U.S. Pat. No. 6,459,782 B1, issued on Oct. 1, 2002 to Bert Bedrosian et al., describes a method and system for generating instructions enabling navigation between and a location identified by an address corresponding to data in an incomming communciation, such as a customer name or customer telephone number. Bedrosian et al. does not suggest a system and method for obtaining driving directions according to the claimed invention.

European Patent Application No. 1 124 140 A1, published on Aug. 16, 2001, describes a method for determining the location of a mobile station in a cellular radio communication system having a plurality of base stations. The European application does not suggest a system and method for obtaining driving directions according to the claimed invention.

None of the above inventions and patents, taken either singularly or in combination, is seen to describe the instant invention as claimed. Thus a system and method for obtaining driving directions solving the aforementioned problems is desired.

### SUMMARY OF THE INVENTION

The present invention provides a system and method for obtaining driving directions. A system for obtaining driving directions includes at least one user communication device and an address/mapping communication device.

The user communication device may be a wireless communication device, a wireless telephone, a personal computer, and/or a wireline telephone. Wireless communication devices, wireless telephones, personal computers, and wireline telephones are well known in the communication art so no further discussion is included herein. Any type of wireless communication device, wireless telephone, personal computer, or wireline telephone may be used for the system and method for obtaining driving directions according to the invention. For example, a wireless telephone may be used that is or is not configured with a global positioning receiver for providing longitude and latitude coordinates of the wireless telephone.

The address/mapping communication device includes a microprocessor and memory, and may be functioning as a server/database of an address/mapping internet web site via the internet. The microprocessor includes an arithmetic/logic unit that is interconnected with the memory via a communication bus. The memory includes a read only memory (ROM) and a random access memory (RAM) The ROM stores computer readable program code means that is read and processed by the microprocessor, and that causes the microprocessor to perform programmed functions. The ROM may be electronically alterable (e.g., electrically programmable (EPROM), electrically eraseable programmable (EEPROM), or the like) so that the processing circuitry can be readily adapted to a particular address/mapping communication device. Movement and process of instructions as well as data is controlled and accomplished by the microprocessor. The RAM and the ROM may be connected to the microprocessor through several signal paths.

The microprocessor may execute various programs under the control of the operating system of the address/mapping communication device. For example, any computer readable software code means stored in the ROM of the address/mapping communication device may include:

first instruction means for responding to a telephone call from a user communication device;

second instruction means for providing a touch tone or voice option to the user communication device;

third instruction means for receiving ‘from’ side telephone number data from the user communication device;

fourth instruction-means for providing a current location or a billing/service address option to the user communication device for the ‘from’ side telephone number data;

fifth instruction means for receiving ‘to’ side telephone number data from the user communication device;

sixth instruction means for providing a current location or a billing/service address option to the user communication device for the ‘to’ side telephone number data;

seventh instruction means for passing the ‘to’ telephone number data to an address engine on the address/mapping communication device;

eighth instruction means for determining if address data is able to be generated by the address engine on the address/mapping communication device;

ninth instruction means for providing address data from the address engine on the address/mapping communication device to the user communication device if address data can be generated by the address engine on the address/mapping communication device based on the ‘from’ and ‘to’ telephone number data;

tenth instruction means for informing the user communication device that address data is not available if address data cannot be generated by the address engine on the address/mapping communication device;

eleventh instruction means for passing the address data to a mapping engine on the address/mapping communication device if address data can be generated by the address engine on the address/mapping communication device based on the ‘from’ and ‘to’ telephone number data;

twelfth instruction means for determining if mapping data is able to be generated by the mapping engine on the address/mapping communication device based on the address data generated by the address engine on the address/mapping communication device;

thirteenth instruction means for providing mapping data from the mapping engine on the address/mapping communication device to the user communication device if mapping data can be generated by the mapping engine on the address/mapping communication device based on the address data generated by the address engine on the address/mapping communication device; and,

fourteenth instruction means for informing the user communication device that mapping data is not available if mapping data cannot be generated by the mapping engine on the address/mapping communication device based on the address data generated by the address engine on the address/mapping communication device, or the like.

A user may access the address/mapping communication device when it is functioning as an internet web site server via the internet by using a personal computer equipped with a wireless or wireline modem. In this case, any computer readable software code means stored in the ROM of the address/mapping communication device may include:

fifteenth instruction means for providing an input window image on the personal computer for obtaining ‘from’ and ‘to’ telephone number data, ‘from’ and ‘to’ current location or a billing/service address options, and an input button for requesting driving directions;

sixteenth instruction means for passing the ‘from’ and ‘to’ telephone number data to an address engine on the address/mapping communication device;

seventeenth instruction means for determining if address data is able to be generated by the address engine on the address/mapping communication device;

eighteenth instruction means for providing driving instruction data to the personal computer on a window image if address data can be generated by the address engine on the address/mapping communication device based on the ‘from’ and ‘to’ telephone number data;

nineteenth instruction means for informing the user of the personal computer that address data is not available if address data cannot be generated by the address engine on the address/mapping communication device based on the ‘from’ and ‘to’ telephone number data;

twentieth instruction means for passing the address data to a mapping engine on the address/mapping communication device if address data can be generated by the address engine on the address/mapping communication device based on the ‘from’ and ‘to’ telephone number data;

twenty-first instruction means for determining if mapping data is able to be generated by the address engine on the address/mapping communication device;

twenty-second instruction means for providing mapping data from the mapping engine on the address/mapping communication device on a window image of the address/mapping communication device if mapping data can be generated by the mapping engine on the address/mapping communication device based on the address data;

twenty-third instruction means for informing the user of the personal computer that mapping data is not available if mapping data cannot be generated by the mapping engine on the address/mapping communication device based on the address data;

twenty-fourth instruction means for sending driving direction data to a predetermined email address if address data can be generated by the address engine on the address/mapping communication device based on the ‘from’ and ‘to’ telephone number data; and,

twenty-fifth instruction means for sending mapping data to a predetermined email address if mapping data can be generated by the mapping engine on the address/mapping communication device based on the address data, or the like.

A method for obtaining driving directions provides a user communication device and an address/mapping communication device communicatively linked to the user communication device. The method then responds to a telephone call from the user communication device and provides a touch tone or voice option to the user communication device.

The address/mapping communication device receives ‘from’ side telephone number data from the user communication device and provides a current location or a billing/service address option to the user communication device. The address/mapping communication device receives ‘to’ side telephone number data from the user communication device and provides a current location or a billing/service address option to the user communication device for the ‘to’ side telephone number data.

The address/mapping communication device passes the ‘to’ telephone number data to an address engine on the address/mapping communication device and determines if address data is able to be generated by the address engine on the address/mapping communication device. The address/mapping communication device obtains address data from the address engine on the address/mapping communication device if address data can be generated by the address engine on the address/mapping communication device based on the ‘from’ and ‘to’ telephone number data. The address/mapping communication device informs the user communication device that address data is not available if address data cannot be generated by the address engine on the address/mapping communication device.

The address/mapping communication device passes the address data to a mapping engine on the address/mapping communication device if address data can be generated by the address engine on the address/mapping communication device based on the ‘from’ and ‘to’ telephone number data, and determines if mapping data is able to be generated by the mapping engine on the address/mapping communication device based on the address data generated by the address engine on the address/mapping communication device. The address/mapping communication device informs the user communication device that mapping data is not available if mapping data cannot be generated by the mapping engine on the address/mapping communication device based on the address data generated by the address engine on the address/mapping communication device. The address/mapping communication device obtains mapping data from the mapping engine on the address/communication device if mapping data can be generated by the mapping engine on the address/communication device.

The address/mapping communication device provides address and/or mapping data from the address engine and/or the mapping engine on the address/mapping communication device to the user communication device if address data and/or mapping data has been obtained by the address/mapping communication device.

Accordingly, it is a principal aspect of the invention to provide a system for obtaining driving directions, the system including at least one user communication device and an address/mapping communication device, wherein the address/mapping communication device provides driving directions to the user communication device based on ‘from’ and ‘to’ telephone number data.

It is another aspect of the invention to provide a system for obtaining driving directions, the system including a user communication device and an address/mapping communication device, wherein the address/mapping communication device provides driving directions to the user communication device based on ‘from’ and ‘to’ telephone number data, and wherein the address/mapping communication device includes a microprocessor and memory, and wherein the memory includes stored therein computer readable software code means that includes:

first instruction means for responding to a telephone call from a user communication device;

second instruction means for providing a touch tone or voice option to the user communication device;

third instruction means for receiving ‘from’ side telephone number data from the user communication device;

fourth instruction means for providing a current location or a billing/service address option to the user communication device for the ‘from’ side telephone number data;

fifth instruction means for receiving ‘to’ side telephone number data from the user communication device;

sixth instruction means for providing a current location or a billing/service address option to the user communication device for the ‘to’ side telephone number data;

seventh instruction means for passing the ‘to’ telephone number data to an address engine on the address/mapping communication device;

eighth instruction means for determining if address data is able to be generated by the address engine on the address/mapping communication device;

ninth instruction means for providing address data from the address engine on the address/mapping communication device to the user communication device if address data can be generated by the address engine on the address/mapping communication device based on the ‘from’ and ‘to’ telephone number data;

tenth instruction means for informing the user communication device that address data is not available if address data cannot be generated by the address engine on the address/mapping communication device;

eleventh instruction means for passing the address data to a mapping engine on the address/mapping communication device if address data can be generated by the address engine on the address/mapping communication device based on the ‘from’ and ‘to’ telephone number data;

twelfth instruction means for determining if mapping data is able to be generated by the mapping engine on the address/mapping communication device based on the address data generated by the address engine on the address/mapping communication device;

thirteenth instruction means for providing mapping data from the mapping engine on the address/mapping communication device to the user communication device if mapping data can be generated by the mapping engine on the address/mapping communication device based on the address data generated by the address engine on the address/mapping communication device; and

fourteenth instruction means for informing the user communication device that mapping data is not available if mapping data cannot be generated by the mapping engine on the address/mapping communication device based on the address data generated by the address engine on the address/mapping communication device.

It is a further aspect of the invention to provide a system for obtaining driving directions, the system including at least one user communication device and an address/mapping communication device, wherein the address/mapping communication device provides driving directions to the user communication device based on ‘from’ and ‘to’ telephone number data, and wherein the at least one user communication device is a personal computer, the address/mapping communication device including a microprocessor and memory, and wherein the memory includes stored therein computer readable software code means, the computer readable software code means including:

fifteenth instruction means for providing an input window image on the personal computer for obtaining ‘from’ and ‘to’ telephone number data, ‘from’ and ‘to’ current location or a billing/service address options, and an input button for requesting driving directions;

sixteenth instruction means for passing the ‘from’ and ‘to’ telephone number data to an address engine on the address/mapping communication device;

seventeenth instruction means for determining if address data is able to be generated by the address engine on the address/mapping communication device;

eighteenth instruction means for providing driving instruction data to the personal computer on a window image if address data can be generated by the address engine on the address/mapping communication device based on the ‘from’ and ‘to’ telephone number data;

nineteenth instruction means for informing the user of the personal computer that address data is not available if address data cannot be generated by the address engine on the address/mapping communication device based on the ‘from’ and ‘to’ telephone number data;

twentieth instruction means for passing the address data to a mapping engine on the address/mapping communication device if address data can be generated by the address engine on the address/mapping communication device based on the ‘from’ and ‘to’ telephone number data;

twenty-first instruction means for determining if mapping data is able to be generated by the address engine on the address/mapping communication device;

twenty-second instruction means for providing mapping data from the mapping engine on the address/mapping communication device on a window image of the address/mapping communication device if mapping data can be generated by the mapping engine on the address/mapping communication device based on the address data;

twenty-third instruction means for informing the user of the personal computer that mapping data is not available if mapping data cannot be generated by the mapping engine on the address/mapping communication device based on the address data; and

twenty-fourth instruction means for sending driving direction data to a predetermined email address if address data can be generated by the address engine on the address/mapping communication device based on the ‘from’ and ‘to’ telephone number data.

Still another aspect of the invention is to provide a method of obtaining driving directions, the method including:

providing a user communication device;

providing an address/mapping communication device communicatively linked to the user communication device;

responding to a telephone call from the user communication device by the address/mapping communication device; providing a touch tone or voice option to the user communication device by the address/mapping communication device;

receiving ‘from’ side telephone number data from the user communication device by the address/mapping communication device;

providing a current location or a billing/service address option to the user communication device from the address/mapping communication device; receiving ‘to’ side telephone number data from the user communication device by the address/mapping communication device;

providing a current location or a billing/service address option for the ‘to’ side telephone number data to the user communication device from the address/mapping communication device;

passing the ‘to’ telephone number data to an address engine on the address/mapping communication device; determining if address data is able to be generated by the address engine on the address/mapping communication device;

obtaining address data from the address engine on the address/mapping communication device if address data can be generated by the address engine on the address/mapping communication device based on the ‘from’ and ‘to’ telephone number data;

informing the user communication device that address data is not available if address data cannot be generated by the address engine on the address/mapping communication device;

passing the address data to a mapping engine on the address/mapping communication device if address data can be generated by the address engine on the address/mapping communication device based on the ‘from’ and ‘to’ telephone number data;

determining if mapping data is able to be generated by the mapping engine on the address/mapping communication device based on the address data generated by the address engine on the address/mapping communication device;

informing the user communication device that mapping data is not available if mapping data cannot be generated by the mapping engine on the address/mapping communication device based on the address data generated by the address engine on the address/mapping communication device;

obtaining mapping data from the mapping engine on the address/communication device if mapping data can be generated by the mapping engine on the address/communication device; and

providing address and/or mapping data from the address engine and/or the mapping engine on the address/mapping communication device to the user communication device if address data and/or mapping data has been obtained by the address/mapping communication device.

It is an aspect of the invention to provide improved elements and arrangements thereof in a system and method for obtaining driving directions for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a block diagram of an apparatus for obtaining driving directions according to the present invention.

FIGS. 2A and 2B are a flow chart of a method for obtaining driving directions according to the present invention.

FIG. 3 is an driving direction entry screen according to the present invention.

FIG. 4 is a driving direction instruction screen according to the present invention.

Similar reference characters denote corresponding features consistently throughout the attached drawings.

### DETAILED DESCRIPTION OF THE PREFERRED EMBODIMENTS

The present invention is a system and method for obtaining driving directions. The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

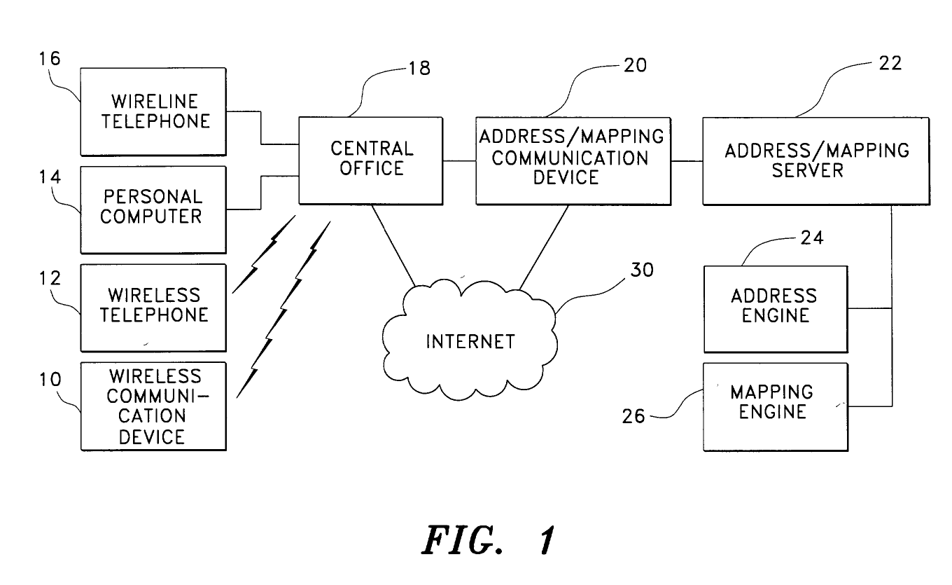

Referring to the drawings, FIG. 1 illustrates a block diagram of a system for obtaining driving directions according to the invention. The system includes at least one user communication device 10, 12, 14, 16 and an address/mapping communication device 20.

The user communication device may be a wireless communication device 10, a wireless telephone 12, a personal computer 14, and/or a wireline telephone 16. Wireless communication devices, wireless telephones, personal computers, and wireline telephones are well known in the communication art so no further discussion is included herein. Any type of wireless communication device 10, wireless telephone 12, personal computer 14, and/or wireline telephone 16 may be used for the system and method for obtaining driving directions according to the invention. For example, a wireless telephone 12 may be used that is or is not configured with a global positioning receiver for providing longitude and latitude coordinates of the wireless telephone 12.

The address/mapping communication device 20 includes a microprocessor and memory, and may be functioning as a server/database 22 of an address/mapping internet web site via the internet 30. The microprocessor includes an arithmetic/logic unit that is interconnected with the memory via a communication bus. The memory includes a ROM and a RAM. The ROM stores computer readable program code means that is read and processed by the microprocessor, and that causes the microprocessor to perform programmed functions. The ROM may be electronically alterable (e.g., EPROM, EEPROM, or the like) so that the processing circuitry can be readily adapted to a particular address/mapping communication device. Movement and process of instructions as well as data is controlled and accomplished by the microprocessor. The RAM and the ROM may be connected to the microprocessor through several signal paths.

The microprocessor may execute various programs under the control of the operating system of the address/mapping communication device. For example, any computer readable software code means stored in the ROM of the address/mapping communication device 20 may include first instruction means for responding to a telephone call from a user communication device 10, 12, 14, 16, second instruction means for providing a touch tone or voice option to the user communication device 10, 12, 14, 16, third instruction means for receiving ‘from’ side telephone number data from the user communication device 10, 12, 14, 16, fourth instruction means for providing a current location or a billing/service address option to the user communication device 10, 12, 14, 16 for the ‘from’ side telephone number data, fifth instruction means for receiving ‘to’ side telephone number data from the user communication device 10, 12, 14, 16, sixth instruction means for providing a current location or a billing/service address option to the user communication device 10, 12, 14, 16 for the ‘to’ side telephone number data.

The computer readable software code means stored on the ROM of the address/mapping communication device may also include seventh instruction means for passing the ‘to’ telephone number data to an address engine 24 on the address/mapping communication device 20, eighth instruction means for determining if address data is able to be generated by the address engine 24 on the address/mapping communication device 20, ninth instruction means for providing address data from the address engine 24 of the address/mapping communication device 20 to the user communication device 10, 12, 14, 16 if address data can be generated by the address engine 24 on the address/mapping communication device 20 based on the ‘from’ and ‘to’ telephone number data, tenth instruction means for informing the user communication device 10, 12, 14, 16 that address data is not available if address data cannot be generated by the address engine 24 on the address/mapping communication device 20. For these seventh through tenth instruction means, any address data generatable by the address engine will be generated according to the current location or a billing/service address option selected by the user of the user communication device 10, 12, 14, 16 for the ‘from’ and ‘to’ side telephone number data.

The computer readable software code means stored on the ROM of the address/mapping communication device may also include eleventh instruction means for passing the address data to a mapping engine 26 on the address/mapping communication device 20 if address data can be generated by the address engine 24 on the address/mapping communication device 20 based on the ‘from’ and ‘to’ telephone number data, twelfth instruction means for determining if mapping data is able to be generated by the mapping engine 26 on the address/mapping communication device 20 based on the address data generated by the address engine 24 on the address/mapping communication device 20, thirteenth instruction means for providing mapping data from the mapping engine 26 of the address/mapping communication device 20 to the user communication device 10, 12, 14, 16 if mapping data can be generated by the mapping engine 26 on the address/mapping communication device 20 based on the address data generated by the address engine 24 on the address/mapping communication device 20, and fifteenth instruction means for informing the user communication device 10, 12, 14, 16 that mapping data is not available if mapping data cannot be generated by the mapping engine 26 on the address/mapping communication device 20 based on the address data generated by the address engine 24 on the address/mapping communication device 20, or the like. For these eleventh through fifteenth instruction means, any mapping data generatable by the mapping engine will be generated according to the current location or a billing/service address option selected by the user of the user communication device 10, 12, 14, 16 for the ‘from’ and ‘to’ side telephone number data.

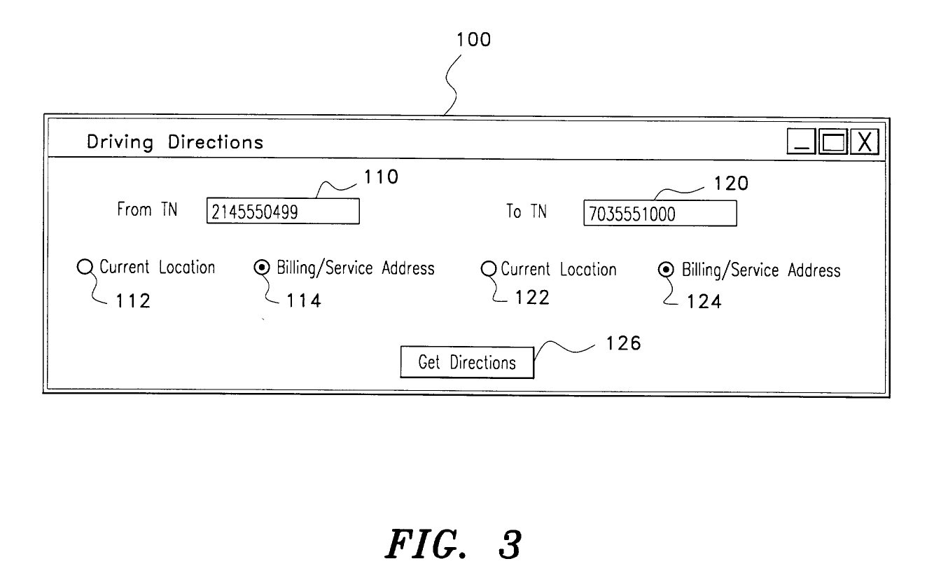

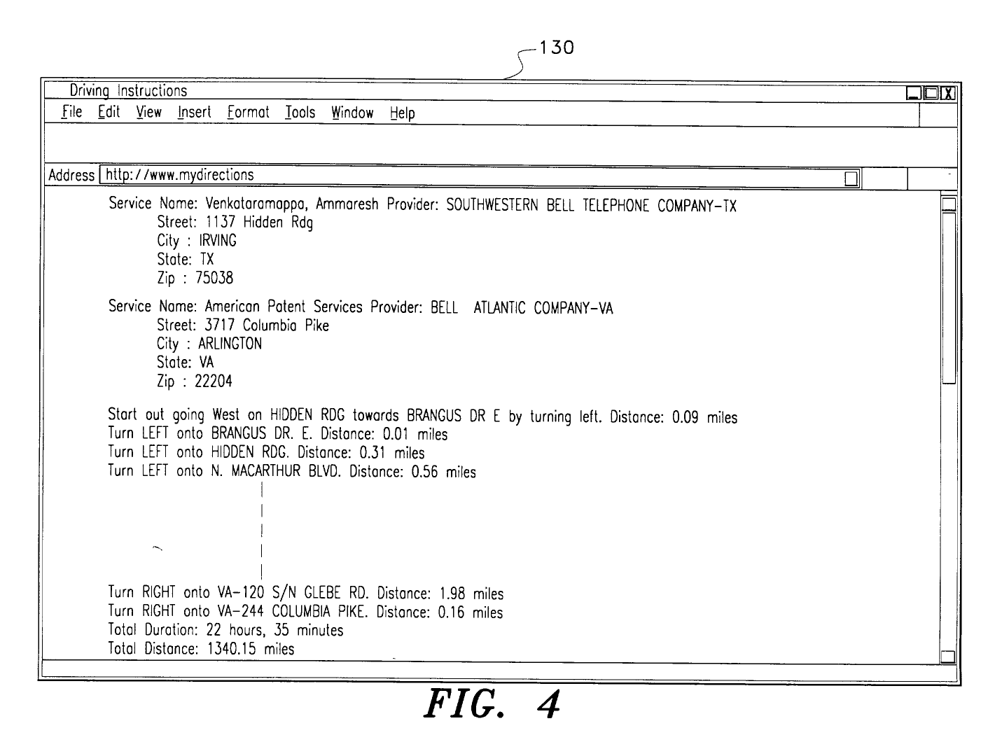

Referring to FIGS. 3 and 4, a user may access the address/mapping communication device 20 when it is functioning as an internet web site server 22 via the internet 30 by using a personal computer 14 equipped with a wireless or wireline modem. In this case, any computer readable software code means stored in the ROM of the address/mapping communication device 20 may include fifteenth instruction means for providing an input window image 100 for obtaining ‘from’ and ‘to’ telephone number data 110, 120, ‘from’ and ‘to’ current location or a billing/service address options 112, 114, 122, 124, and an input button 126 for requesting driving directions.

Any computer readable software code means stored in the ROM of the address/mapping communication device 20 may also include sixteenth instruction means for passing the ‘from’ and ‘to’ telephone number data 110, 120 to an address engine 24 on the address/mapping communication device 20, seventeenth instruction means for determining if address data is able to be generated by the address engine 24 on the address/mapping communication device 20, eighteenth instruction means for providing driving instruction data to the personal computer 14 on a window image 130 if address data can be generated by the address engine 24 on the address/mapping communication device 20 based on the ‘from’ and ‘to’ telephone number data 110, 120, nineteenth instruction means for informing the user of the personal computer 14 that address data is not available if address data cannot be generated by the address engine 24 on the address/mapping communication device 20 based on the ‘from’ and ‘to’ telephone number data 110, 120. For these sixteenth through nineteenth instruction means, any address data generatable by the address engine will be generated according to the current location or a billing/service address options 112, 114, 122, 124 selected by the user of the personal computer 14 for the ‘from’ and ‘to’ side telephone number data.

Any computer readable software code means stored in the ROM of the address/mapping communication device 20 may also include twentieth instruction means for passing the address data to a mapping engine 26 on the address/mapping communication device 20 if address data can be generated by the address engine 24 on the address/mapping communication device 20 based on the ‘from’ and ‘to’ telephone number data 110, 120, twenty-first instruction means for determining if mapping data is able to be generated by the mapping engine 26 on the address/mapping communication device 20, twenty-second instruction means for providing mapping data from the mapping engine 26 on the address/mapping communication device 20 on a window image 130 of the personal computer 14 if mapping data can be generated by the mapping engine 26 on the address/mapping communication device 20 based on the address data, twenty-third instruction means for informing the user of the personal computer 14 that mapping data is not available if mapping data cannot be generated by the mapping engine 26 on the address/mapping communication device 20 based on the address data, twenty-fourth instruction means for sending driving direction data to a predetermined email address if address data can be generated by the address engine 24 on the address/mapping communication device 20 based on the ‘from’ and ‘to’ telephone number data 110, 120, twenty-fifth instruction means for sending mapping data to a predetermined email address if mapping data can be generated by the mapping engine 26 on the address/mapping communication device 20 based on the address data, or the like. For these twentieth through twenty-fifth instruction means, any mapping data generatable by the mapping engine will be generated according to the current location or a billing/service address options 112, 114, 122, 124 selected by the user of the personal computer 14 for the ‘from’ and ‘to’ side telephone number data.

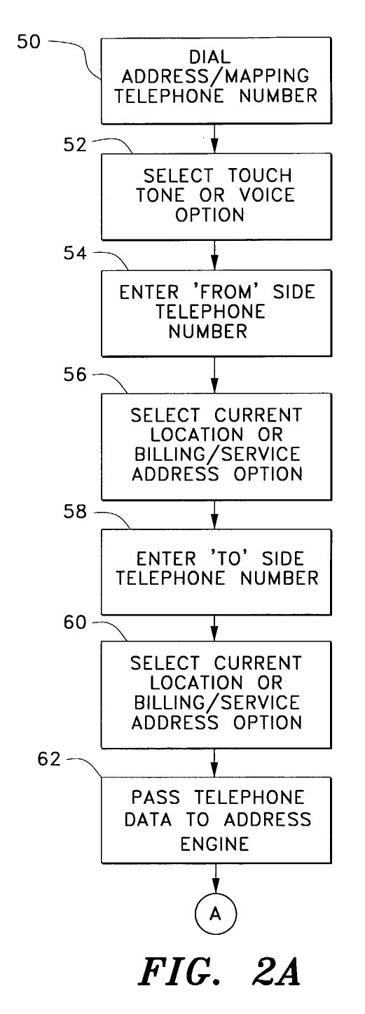

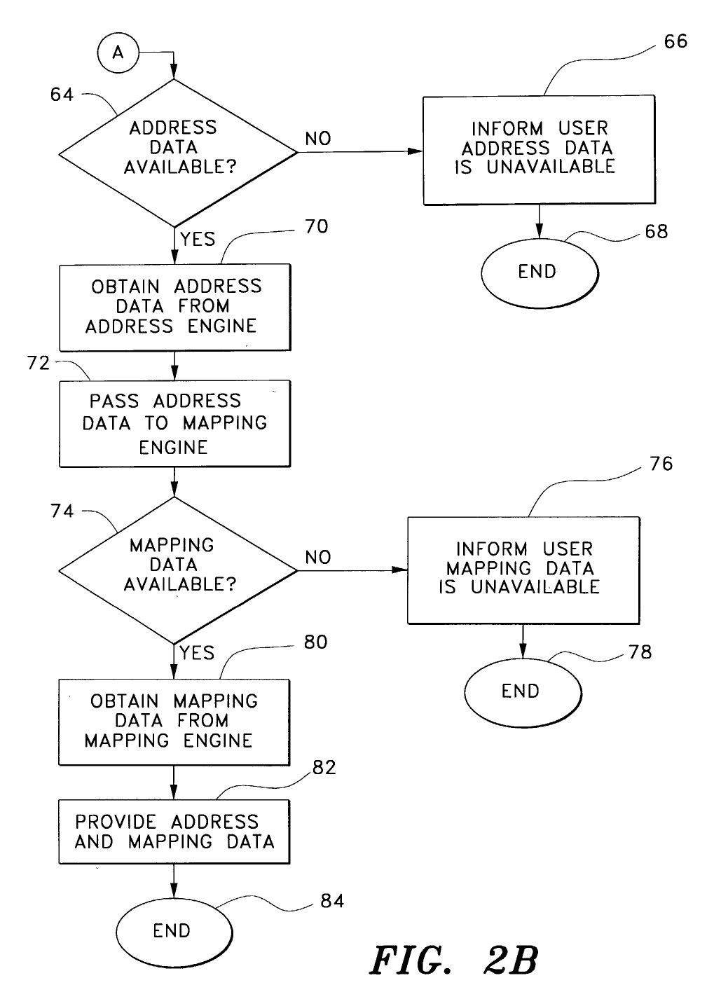

A flow chart for a method for obtaining driving directions is shown in FIGS. 2A and 2B. The method provides a user communication device and an address/mapping communication device communicatively linked to the user communication device. The address/mapping communication device responds to a telephone call from the user communication device 50 and provides a touch tone or voice option 52 to the user communication device.

The address/mapping communication device receives ‘from’ side telephone number data 54 from the user communication device and provides a current location or a billing/service address option 56 to the user communication device. The address/mapping communication device receives ‘to’ side telephone number data 58 from the user communication device and provides a current location or a billing/service address option 60 to the user communication device for the ‘to’ side telephone number data.

The address/mapping communication device passes the ‘to’ telephone number data to an address engine 62 on the address/mapping communication device and determines if address data is able to be generated 64 by the address engine on the address/mapping communication device. The address/mapping communication device obtains address data 70 from the address engine on the address/mapping communication device if address data can be generated by the address engine on the address/mapping communication device based on the ‘from’ and ‘to’ telephone number data. The address/mapping communication device informs the user communication device that address data is not available 66 if address data cannot be generated by the address engine on the address/mapping communication device.

The address/mapping communication device passes the address data to a mapping engine 72 on the address/mapping communication device if address data can be generated by the address engine on the address/mapping communication device based on the ‘from’ and ‘to’ telephone number data, and determines if mapping data is able to be generated 74 by the mapping engine on the address/mapping communication device based on the address data generated by the address engine on the address/mapping communication device. The address/mapping communication device informs the user communication device that mapping data is not available 76 if mapping data cannot be generated by the mapping engine on the address/mapping communication device based on the address data generated by the address engine on the address/mapping communication device. The address/mapping communication device obtains mapping data from the mapping engine on the address/communication device if mapping data can be generated by the mapping engine on the address/communication device.

The address/mapping communication device provides address and/or mapping data 82 from the address engine and/or the mapping engine on the address/mapping communication device to the user communication device if address data and/or mapping data has been obtained by the address/mapping communication device.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A system for obtaining driving directions, said system comprising:
a user communication device; and
address/mapping communication device, wherein said address/mapping communication device provides driving directions to the user communication device based on ‘from’ and ‘to’ telephone number data.

2. The system according to claim 1, wherein said address/mapping communication device comprises a microprocessor and memory, and wherein said memory includes stored therein computer readable software code means, said computer readable software code means comprising:
first instruction means for responding to a telephone call from a user communication device;
second instruction means for providing a touch tone or voice option to the user communication device;
third instruction means for receiving ‘from’ side telephone number data from the user communication device;
fourth instruction means for providing a current location or a billing/service address option to the user communication device for the ‘from’ side telephone number data;
fifth instruction means for receiving ‘to’ side telephone number data from the user communication device;
sixth instruction means for providing a current location or a billing/service address option to the user communication device for the ‘to’ side telephone number data;
seventh instruction means for passing the ‘to’ telephone number data to an address engine on the address/mapping communication device;
eighth instruction means for determining if address data is able to be generated by the address engine on the address/mapping communication device;
ninth instruction means for providing address data from the address engine on the address/mapping communication device to the user communication device if address data can be generated by the address engine on the address/mapping communication device based on the ‘from’ and ‘to’ telephone number data;
tenth instruction means for informing the user communication device that address data is not available if address data cannot be generated by the address engine on the address/mapping communication device;
eleventh instruction means for passing the address data to a mapping engine on the address/mapping communication device if address data can be generated by the address engine on the address/mapping communication device based on the ‘from’ and ‘to’ telephone number data;
twelfth instruction means for determining if mapping data is able to be generated by the mapping engine on the address/mapping communication device based on the address data generated by the address engine on the address/mapping communication device;
thirteenth instruction means for providing mapping data from the mapping engine on the address/mapping communication device to the user communication device if mapping data can be generated by the mapping engine on the address/mapping communication device based on the address data generated by the address engine on the address/mapping communication device; and
fourteenth instruction means for informing the user communication device that mapping data is not available if mapping data cannot be generated by the mapping engine on the address/mapping communication device based on the address data generated by the address engine on the address/mapping communication device.

3. The system according to claim 1, wherein said user communication device is a wireless telephone.

4. The system according to claim 1, wherein said user communication device is a wireless communication device.

5. The system according to claim 1, wherein said user communication device is a personal computer.

6. The system according to claim 2, wherein said user communication device is a personal computer, and wherein computer readable software code means further comprises:
fifteenth instruction means for providing an input window image on the personal computer for obtaining ‘from’ and ‘to’ telephone number data, ‘from’ and ‘to’ current location or a billing/service address options, and an input button for requesting driving directions;
sixteenth instruction means for passing the ‘from’ and ‘to’ telephone number data to an address engine on the address/mapping communication device;
seventeenth instruction means for determining if address data is able to be generated by the address engine on the address/mapping communication device;
eighteenth instruction means for providing driving instruction data to the personal computer on a window image if address data can be generated by the address engine on the address/mapping communication device based on the ‘from’ and ‘to’ telephone number data;
nineteenth instruction means for informing the user of the personal computer that address data is not available if address data cannot be generated by the address engine on the address/mapping communication device based on the ‘from’ and ‘to’ telephone number data;
twentieth instruction means for passing the address data to a mapping engine on the address/mapping communication device if address data can be generated by the address engine on the address/mapping communication device based on the ‘from’ and ‘to’ telephone number data;
twenty-first instruction means for determining if mapping data is able to be generated by the address engine on the address/mapping communication device;
twenty-second instruction means for providing mapping data from the mapping engine on the address/mapping communication device on a window image of the address/mapping communication device if mapping data can be generated by the mapping engine on the address/mapping communication device based on the address data;
twenty-third instruction means for informing the user of the personal computer that mapping data is not available if mapping data cannot be generated by the mapping engine on the address/mapping communication device based on the address data; and
twenty-fourth instruction means for sending driving direction data to a predetermined email address if address data can be generated by the address engine on the address/mapping communication device based on the ‘from’ and ‘to’ telephone number data. 7. The system according to claim 6, said computer readable software code means further comprises twenty-fifth instruction means for sending mapping data to a predetermined email address if mapping data can be generated by the mapping engine on the address/mapping communication device based on the address data. 8. A method for obtaining driving directions, said method comprising:
providing a user communication device;
providing an address/mapping communication device communicatively linked to the user communication device;
responding to a telephone call from the user communication device by the address/mapping communication device;
providing a touch tone or voice option to the user communication device by the address/mapping communication device;
receiving ‘from’ side telephone number data from the user communication device by the address/mapping communication device;
providing a current location or a billing/service address option to the user communication device from the address/mapping communication device;
receiving ‘to’ side telephone number data from the user communication device by the address/mapping communication device;
providing a current location or a billing/service address option for the ‘to’ side telephone number data to the user communication device from the address/mapping communication device;
passing the ‘to’ telephone number data to an address engine on the address/mapping communication device determining if address data is able to be generated by the address engine on the address/mapping communication device;
obtaining address data from the address engine on the address/mapping communication device if address data can be generated by the address engine on the address/mapping communication device based on the ‘from’ and ‘to’ telephone number data;
informing the user communication device that address data is not available if address data cannot be generated by the address engine on the address/mapping communication device;
passing the address data to a mapping engine on the address/mapping communication device if address data can be generated by the address engine on the address/mapping communication device based on the ‘from’ and ‘to’ telephone number data;
determining if mapping data is able to be generated by the mapping engine on the address/mapping communication device based on the address data generated by the address engine on the address/mapping communication device;
informing the user communication device that mapping data is not available if mapping data cannot be generated by the mapping engine on the address/mapping communication device based on the address data generated by the address engine on the address/mapping communication device;
obtaining mapping data from the mapping engine on the address/communication device if mapping data can be generated by the mapping engine on the address/communication device; and
providing address and/or mapping data from the address engine and/or the mapping engine on the address/mapping communication device to the user communication device if address data and/or mapping data has been obtained by the address/mapping communication device.
